(19) United States
(12) Patent Application Publication
(10) Pub. No.: US 2025/0006395 A1
(43) Pub. Date: Jan. 2, 2025

(54) CONVERTERLESS CONVERSION OF RADIUM-226 TO ACTINIUM-225

(71) Applicant: Northstar Medical Technologies, LLC, Beloit, WI (US)

(72) Inventor: Omar NUSAIR, Rockford, IL (US)

(73) Assignee: Northstar Medical Technologies, LLC, Beloit, WI (US)

(21) Appl. No.: 18/757,986

(22) Filed: Jun. 28, 2024

Related U.S. Application Data
(60) Provisional application No. 63/523,992, filed on Jun. 29, 2023.

(51) Int. Cl. G21G 1/10; G21G 1/00

(52) U.S. Cl. CPC G21G 1/10; G21G 1/001; G21G 2001/0089

(57) ABSTRACT

A converterless method for converting ²²⁶Ra to ²²⁵Ac by direct electron beam bombardment with high energy electron beam having an average effective beam power of about 20 to about 250 kW at a beam energy of about 25 to about 100 MeV to impact the ²²⁶Ra is disclosed. Contrary to other electron-based bombardment methods, the present method is carried out without a converter that slows the electrons and transforms their kinetic energy into Bremsstrahlung photons, but rather into the production of virtual photons that transmute the target ²²⁶Ra to ²²⁵Ra that decays to ²²⁵Ac.

### CROSS-REFERENCE TO RELATED APPLICATION

This application claims priority to U.S. application Ser. No. 63/523,992, filed on Jun. 29, 2023, whose disclosures are incorporated herein by reference.

### TECHNICAL FIELD

The present invention relates to the preparation of ²²⁵Ac from ²²⁶Ra target by the bombardment of that radium isotope with a high energy electron beam to produce virtual photons electromagnetic radiation that transmutes the ²²⁶Ra to ²²⁵Ra and ²²⁵Fr both of which decay to ²²⁵Ac. This photonuclear reaction is carried out without the use of an intervening Bremsstrahlung-converter between the electron beam and the target ²²⁶Ra.

### BACKGROUND ART

The quest for bridging the gap between the severely constrained ²²⁵Ac (which has a half-life T_{1/2}=9.92 days) supply and the large worldwide demand for that isotope is a key factor in nuclear medicine. The demand for ²²⁵Ac stems from the use of that isotope in targeted alpha therapy (TAT). Radioisotope ²²⁵Ac and its daughter ²¹³Bi (T_{1/2}=45.61 minutes) are used in medicine for the treatment of several cancers, including prostate, brain, and neuroendocrine cancers.

In one of the usual methods of production, ²²⁵Ac is produced via the β⁻-decay of ²²⁵Ra (T_{1/2}=14.9 days), which is itself produced by the (γ,n) reaction on a high-purity ²²⁶Ra (T_{1/2}=1600 years) target. The photons are produced by a solid converter of high atomic number (high-Z) material, such as tantalum, via the braking-radiation (Bremsstrahlung) mechanism that can result from slowing down very energetic accelerated electrons impinging on the converter material. The Bremsstrahlung thereby produced are high energy photons that impinge upon the target ²²⁶Ra and cause the ²²⁶Ra to transmute into another radioisotope, ²²⁵Ra that decays via the β⁻-decay to ²²⁵Ac.

However, the typical photon spectrum generated using a converter is widely dispersed in terms of energy (see FIG. 1) and also to an extent in terms of the emission angle (see FIG. 2). Moreover, around 80% of the photon flux spectrum is below the neutron separation energy (e.g., Sₙ) of ²²⁶Ra (Sₙ=6.39 MeV), which makes those photons sterile, but can catastrophically overheat the target and its surrounding materials. Such overheating requires enhanced cooling and, consequently enhanced radio-waste removal systems.

Two tantalum disk converters were used previously to enhance cooling and heat removal. They are shown in FIGS. 1 and 2 as illustrative of difficulties found when using converters. The use of more than a single converter was proposed by Diamond et al., J Appl Phys 129:104901 (Mar. 9, 2021).

In addition, with the use of converters, the proton-removal channel that produces an important precursor of the ²²⁵Ra, i.e., ²²⁵Fr (T_{1/2}=3.95 m), via photon bombardment (irradiation) of the ²²⁶Ra target is not feasible. The deficiency stems from the anticipated very low yield due to the very low photon flux level at the energy where the (γ,p) reaction cross-section has its peak value σₘₐₓ(30 MeV)=0.2 mb.

Alternatively, without a converter, and as a result of the electrons traveling with an ultra-relativistic speed (Energy>>Mₒ) and hitting the high-Z ₈₈²²⁶Ra target, a new class of interaction with the time-varying Coulomb field takes place. This interaction, named Coulomb Dissociation (CD), can be interpreted as an absorption of a virtual photon [Bertulani et al., Physics Reports 163:299-408, 1988; and International Atomic Energy Agency, Handbook on Photonuclear Data for Applications: Cross sections and Spectra, I.A.E.A TECDOC 1178 (2000), Sections 3.1.4 and 4.4].

The absorption probability can be translated into (γ,n) and (γ,p) cross-sections, which can be experimentally measured using several techniques. One of these techniques is the activation and delayed counting method. Many measurements were performed in the past using this technique on a variety of different beam-target systems. The work reported in [Gerab et al., Phys Rev C, 48(1):105-108 (1993); Martins et al;., Phys. Rev. C, 16:613 (1977); and Shotter et al., Nucl Phys A330:325 (1979)] for accelerated electrons incident on ²³⁸U are of special interest due to their seeming similarity to the reactions here for the production of ²²⁵Ra/²²⁵Ac via (e⁻,n) and (e⁻,p) on ²²⁶Ra.

The similarity in the nuclear structures between both target nuclear systems, i.e., ²³⁸U and ²²⁶Ra, suggests using the same optical model potential (OPM) parameters for the distorted-wave Born approximation (DWBA) calculation as the reaction model for both systems when interacting with E1 and E2 virtual photons generated from the ultra-relativistic electrons. As noted in FIG. 3, which is adopted from Gerab et al., above, and replotted here using the JANIS database [JANIS Database (Nuclear Energy Agency (NEA)—JANIS (oecd-nea.org)], the cross-section for removing a neutron from a ²³³U nucleus at 40 MeV of beam energy is about 2.5 mb. ²²⁶Ra is believed to exhibit a similar value of the (e⁻,n) reaction cross-section. However, a slightly lower value for the (e⁻,p) reaction cross-section is believed to be present due to the need for protons to tunnel out of the radium nucleus Coulomb barrier when absorbing a virtual photon.

As discussed in detail hereinafter, the present invention contemplates a converterless approach for the production of ²²⁵Ac by direct bombardment of an encapsulated ²²⁶Ra target with electron beams with an average power of about 20 to 250 kW. In this method, the well-established and validated CD mechanism of nuclear disintegration is employed when electrons impinge on a thin-target of ²²⁶Ra.

### BRIEF SUMMARY OF THE INVENTION

The present invention contemplates the production of ²²⁵Ac by the absorption of virtual photons by ²²⁶Ra, followed by spontaneous neutron or proton removal to produce ²²⁵Ra and ²²⁵Fr, respectively, and then the formation of ²²⁵Ac, which is produced following a beta-minus decay of ²²⁵Ra and ²²⁵Fr. The photons are generated from the direct bombardment of a high-purity ²²⁶Ra enclosed target using a high-intensity electron beam current with about 25 to about 100 MeV of energy. In this implementation, the virtual photons are responsible for the Coulomb Dissociation (CD) of the target, and with the neutron or proton removals from the ²²⁶Ra target, ²²⁵Ac can be produced following the naturally occurring beta-minus decay of ²²⁵Ra and ²²⁵Fr, respectively. The average electron beam intensity is at about 20 to 250 kW of effective beam power at about 25 to about 100 MeV. The higher efficiency is a result of having a focused and mono-energetic beam of electrons.

Previous methods for ²²⁵Ac production with photons use beam converters to convert the electron beam energy into bremsstrahlung photons, from which about 81% are produced below the neutron-removal threshold. Such previous methods utilize converters of high-Z material to produce photons that are emitted with a large angle. This type of production reduces the number of photons on target. The result is a low production yield. Moreover, the efficiency of these methods is very low, and the designs of such setups are complex.

In this embodiment, there is no actual beam converter. The ²²⁶Ra is directly bombarded with about 25 to about 100 MeV electrons. Optionally, a thin layer (about 120 to about 220 microns) of a high-Z material as are well-known, such as gold (Au), tantalum (Ta) or tungsten (W), present on the inner wall of the enclosure lid produces Bremsstralung photons [Gerab et al., Phys Rev C, 48(1):105-108 (1993)].

More specifically, the present invention contemplates a method for converting ²²⁶Ra to ²²⁵Ac by electron stream bombardment with high energy electrons that comprises the following steps. The words “bombardment” and “irradiation” are used interchangeably herein. ²²⁶Ra present within a hermetically sealed capsule is bombarded with an electron beam with an average electron intensity of about 20 to about 250 kW of effective beam power at about 25 to about 100 MeV electrons.

The capsule has a lid 232 through which the beam of electrons passes prior to impacting the ²²⁶Ra. The capsule lid 232 can include high-Z material coating having a thickness of about 120 to about 220 microns (μ) on its internal capsular surface through which the beam of electrons also passes prior to impacting said ²²⁶Ra, but that high-Z material coating is insufficiently thick to provide transmutation reaction-causing amounts of Bremsstrahlung.

The bombardment is maintained for a time period sufficient to remove a neutron or proton from the ²²⁶Ra to form ²²⁵Ra or ²²⁵Fr, respectively. The ²²⁵Ra and ²²⁵Fr that are formed decay into ²²⁵Ac, which is typically recovered from the irradiated target material and is also typically separated from any remaining ²²⁶Ra and formed ²²⁵Ra or ²²⁵Fr. The ²²⁵Ra and ²²⁵Fr can be separated through an elution process.

Additionally, any ²²⁷Ac byproduct, which is a decay product of ²²⁷Ra (half-life=42±0.5 minutes) that is produced via a less probable neutron capture reaction on ²²⁶Ra, can be eliminated by discarding a first eluted fraction of actinium a few hours after the end of the bombardment. A few hours of wait time is adequate for the vast majority of the ²²⁷Ra to decay away.

Although bombardment of the ²²⁶Ra does not form ²²⁵Ac directly, the intermediate ²²⁵Fr has a half-life of only about 3.95 hours and is therefore generally absent from the ²²⁶Ra or ²²⁵Ra reaction mixture when the actinium product is obtained. Similarly, although not to the same extent, produced ²²⁵Ra also decays to ²²⁵Ac, albeit more slowly, as shown in FIG. 4. In view of the disappearance of some intermediate product formed from ²²⁶Ra and the obtention of the desired ²²⁵Ac, this method is described as a method for converting ²²⁶Ra into ²²⁵Ac for ease of description.

### BRIEF DESCRIPTION OF THE DRAWINGS

In the drawings forming a part of this disclosure,

FIG. 1 is a graph of a Bremsstrahlung photon flux profile produced by a two-tantalum disk converter that illustrates that any photon with energy below 6.4 MeV does not have the required energy to produce ²²⁵Ra/²²⁵Ac;

FIG. 2 is a MCNP-Simulated spatial distribution of the photons produced by the above two-disk converter, illustrating that a large fraction of the photons do not hit the target, where the target is shown as a black rectangular box in the middle of the circle.

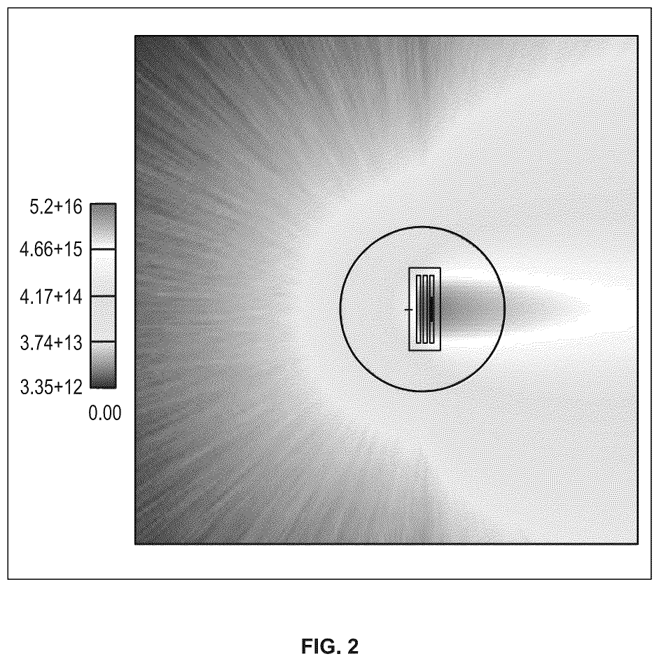

FIG. 3 is a graph showing the virtual-photon induced reaction cross section on a ²³⁸U target (thickness=150 μg/cm²) measured using the (e⁻,n) activation reaction with electron beam energies between 12 and 60 MeV as reported in [Gerab et al., Phys Rev C, 48(1):105-108 (1993)], the plot is generated using the JANIS EXFOR Database [Nuclear Energy Agency (NEA)—JANIS (oecd-nea.org)].

FIG. 4 is a graph showing the relative activities of ²²⁵Ac to ²²⁵Ra over a time of storage as calculated in Maslov et al., Radiochemistry, 48(2):195-197 (2006).

FIG. 5 is a schematic depiction of an exemplary system 100 for producing an isotope such as ²²⁵Ac.

FIG. 6 is a schematic drawing of a target capsule enclosure that illustrates five ²²⁶Ra target-containing capsules with the electron beam entering through a window in the enclosure with an electron-absorbing tantalum beam stop to capture the flow of electrons passing into the air-filled enclosure.

FIG. 7 illustrates a block diagram of a beamline according to an exemplary embodiment.

### DETAILED DESCRIPTION OF PREFERRED EMBODIMENTS

The present invention contemplates a method for converting ²²⁶Ra to ²²⁵Ac by electron beam bombardment with high energy, about 25 to about 100 MeV, electrons to impact a ²²⁶Ra target. In this reaction, ²²⁶Ra is transformed by neutron loss to ²²⁵Ra, which naturally decays into ²²⁵Ac by beta-minus decay with a half-life of 14.9 days. ²²⁶Ra is also transformed by electron beam bombardment to ²²⁵Fr by proton loss and then to ²²⁵Ac with a half-life of 3.95 hours.

Contrary to prior electron-based bombardment methods, the present method is carried out without a converter of the electron beam energy into Bremsstrahlung photons but rather into the production of virtual photons. In a contemplated method, the estimated yield of ²²⁵Ac using the disclosed systems and methods is about three times higher than the yield that results from the Bremsstrahlung bombardment of the ²²⁶Ra using a converter. This exceptional feature of the converter-less concept makes the need for a higher accelerator beam power less important because similar yields are achievable using about one-third of the power needed when using a converter.

A contemplated method is basically a neutron or proton removal process. Conventionally, a neutron removal process for producing an isotope, and particularly a radioisotope, involves firing a linear electron accelerator (linac) or Rodotron® at a target along a common axis. However, the conventional method results in a low yield rate of the desired isotope and creates backstreaming radiation that is harmful to equipment downrange from the beamline.

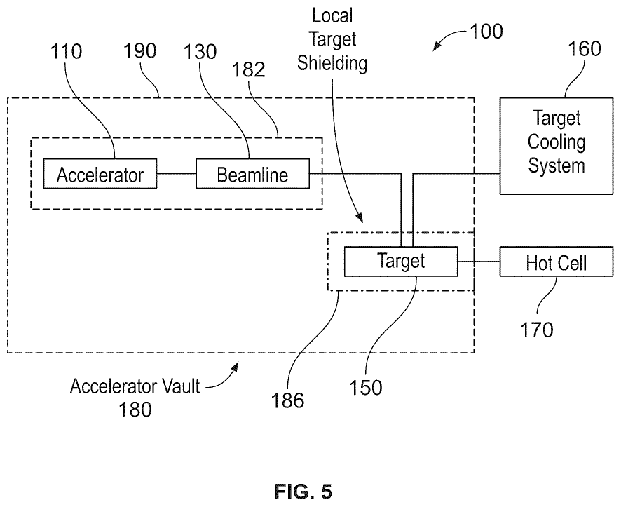

Referring to FIG. 5, an exemplary system 100 is shown for producing an isotope, particularly ²²⁵Ac. Specifically, the system 100 to produce the isotope can comprise an accelerator 110 connected to a first beamline 130. The beamline 130 impacts on a target holder 150. The target holder 150 can be an apparatus where a target isotope, such as ²²⁶Ra, is held for irradiation. The target holder 150 can further engage with a target cooling system 160 (also known as a process cooling system) and a hot cell 170.

The accelerator 110, the beamline 130, and the target holder 150 can be shielded within an accelerator vault 180. In an exemplary embodiment, the accelerator vault 180 can further be separated into a first radiation zone 182, which houses the accelerator 110 and the beamline 130 therein, and a second radiation zone 186, which houses the target holder 150 therein.

In an exemplary embodiment, the accelerator vault 180 together with the interior walls used to form the radiation zones 182 and 186 and any other building rooms can be constructed out of high-density (HD) concrete blocks supplied by Veritas Medical Solutions, Harleysville, PA, USA. HD concrete is better per unit volume at shielding gamma rays, which are the primary source of prompt radiation created in the process, than regular-density concrete.

Specifically, prompt radiation refers to radiation emitted instantaneously during an operation of the accelerator 110, which is different from residual or induced radiation caused by activated components in the accelerator vault 180 or the beamline 130. Although other materials, such as steel or lead, can also be used for the accelerator vault, those materials are more expensive and are not as efficient in stopping prompt neutrons, which are also produced during the process, as HD concrete.

The accelerator 110 generates accelerated electrons to irradiate ²²⁶Ra held in the target holder 150. In an exemplary embodiment, the electron accelerator 110 is capable of supplying about 20 to about 250 kW of average power with about 25 to about 100 MeV electrons. Preferably, the average power value is about 60 to about 200 kW, and more preferably about 80 to about 125 kW. Preferably, the electrons are at about 25 to about 55 MeV.

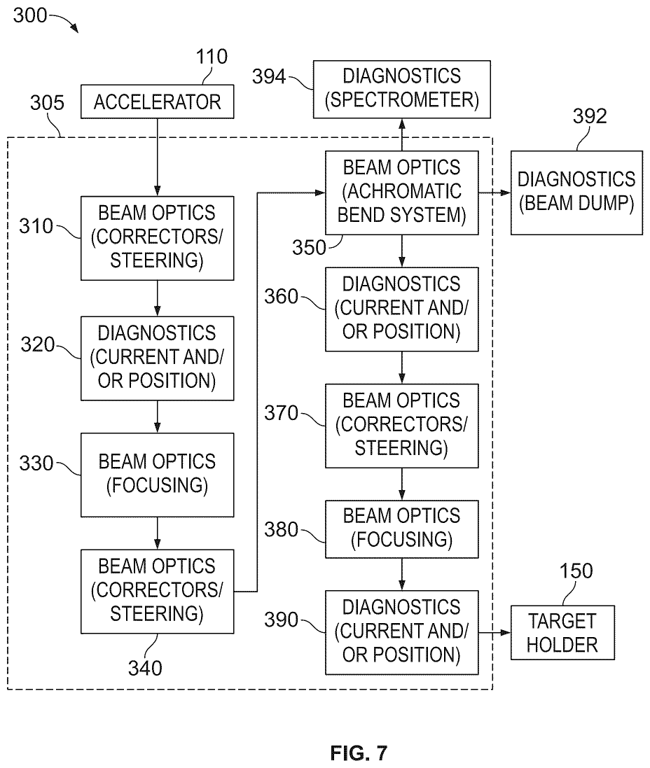

In order to irradiate the target holder 150, a specialized beamline (as shown in FIG. 7) can be used to bend a respective electron beam at an angle toward the target holder 150. In an exemplary embodiment, the beamline 130 bends the electron beam by 90 degrees toward the target holder 150. The invention is not limited to 90 degrees but can include other angles to result in beamlines irradiating the target holder 150 from different directions or degrees. As a result, the target holder 150 may not be placed on a common axis with the accelerator 110. In one exemplary embodiment, the accelerator 110 is offset from the target holder 150, as shown in FIG. 5. In another exemplary embodiment, the accelerator 110 can be placed on a common axis with the target holder 150.

Further, a control system can be provided that integrates individual control systems of the accelerator 110, the beamline 130, the target cooling system 160, the hot cell 170, and other system components for producing a radioisotope such as ²²⁵Ac. For example, the combined control system can be used to time a production of beam pulses by the accelerator 110 such that the beam pulses arrive at the target holder 150 at a desired interval.

As discussed in more detail in FIG. 7, the beamline 130 can accept the electron beam from the accelerator 110 in operation. Then the beamline 130 can bend the respective beam to hit the target holder 150 at a desired spot and avoid backstreaming radiation. After the bend, the beamline 130 aims the beam to that desired spot at the target holder 150, analyzes the energy of the beam, or passes the beam straight through to a waiting beam analyzer and dump.

According to an exemplary embodiment, a Rhodotron® electron beam (e⁻-beam) accelerator, produced by IBA Industrial, Louvain-La-Neuve, Belgium, can be used as the accelerator 110. Unlike a conventional linear accelerator (e.g., linac), a Rhodotron® E-beam accelerator is a pulse wave electron beam accelerator combining high power and high energy. The high-power and high energy properties of a Rhodotron® e⁻-beam accelerator help to improve the production efficiency of ²²⁵Ac, previously unattainable using a linac. Moreover, a Rhodotron® e⁻-beam accelerator is more compact in size, allowing the accelerator setup to take up less square footage in an isotope production facility.

The preferred Rhodotron® e⁻-beam accelerator can provide an electron beam whose diameter is either 7 mm (Full Width at Half Max; FWHM) or 12 mm FWHM. A Gaussian beam with 3 sigma of standard deviation corresponds to 8.9 mm and 15 mm of diameter, respectively. The size of the target in all the simulations used for this disclosure is 25 mm in diameter, with 0.060198 mm of thickness (RaBr₂).

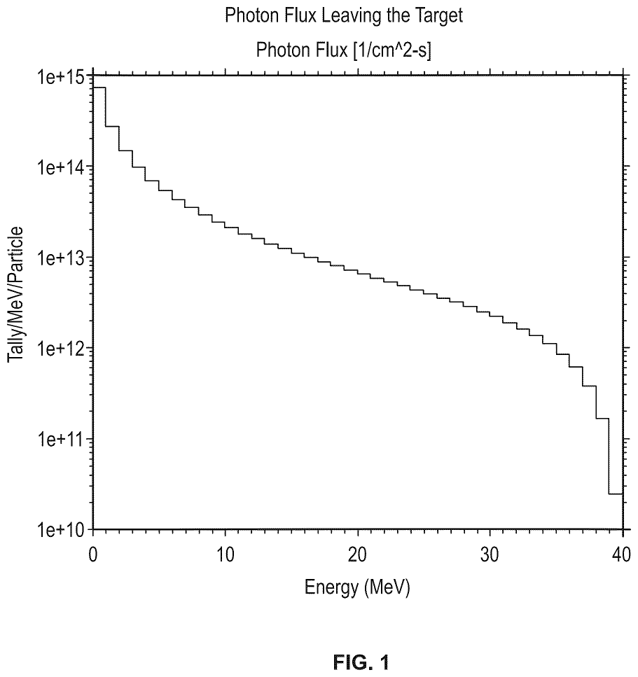

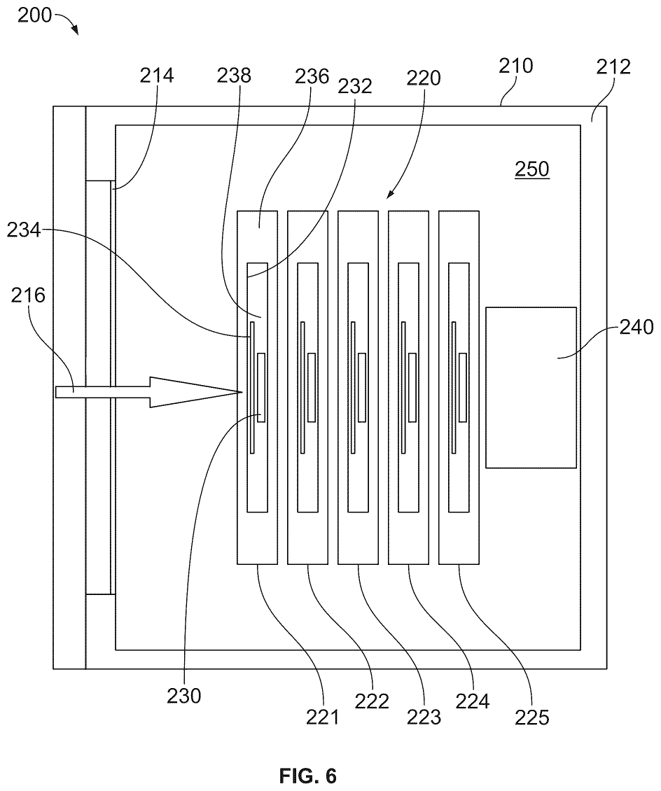

FIG. 6 illustrates a target capsule enclosure system 200. The target capsule enclosure system 200 can be included in, or part of, the target holder 150 of FIG. 1.

The target capsule enclosure system 200 comprises an enclosure 210 designed to encase one or more target capsules 220. The enclosure 210 is comprised of a wall 212, including a window 214 where an electron beam 216, such as an electron beam produced by the accelerator 110 and beamline 130 of FIG. 5, passes through to irradiate the one or more target capsules 220.

As shown in one embodiment, the target capsule enclosure system 200 includes five target capsules 221-225. However, in other embodiments, the target capsule enclosure system 200 can include more or fewer target capsules 220.

Each of the one or more target capsules 220 can be identical. In instances where the target capsule enclosure system 200 includes multiple target capsules 220, each of the target capsules 220 can be arranged along a common axis with a pathway of an electron beam designed to bombard the target capsules 220.

In an exemplary embodiment, as shown in FIG. 6, a long axis of the one or more target capsules 220 are arranged perpendicular to the axis along which the electron beam 216 passes. In other words, the electron beam 216 passes through a “short side” or “short axis” of the one or more target capsules 220. In other embodiments, the long axis of the one or more target capsules 220 can be arranged on the same axis as the electron beam 216.

Many geometries for the one or more target capsules 220 can be utilized. Illustrative examples include a cylindrical-shaped capsule with generally rounded ends where a ²²⁶Ra target 230 is made of RaBr₂, RaCl₂, or Ra(NO₃)₂ salt and present on the inner surface of the capsule base, with a lid 232 coated on its internal surface with a thin layer of tantalum 234 (e.g., the tantalum layer is on an internal capsular surface).

Another embodiment utilizes a cone-shaped or frusto-conical capsule, where the ²²⁶Ra target 230 is on the inner walls of the capsule, whereas an inner surface of the lid 232 is coated only with tantalum. The cone-shaped capsule provides a significant surface area for heat transfer to a coolant fluid (water-based liquid or a chemically inert gas), while distributing and spreading the volumetric heating induced by the electron beam. The coolant flow direction can be perpendicular or parallel to the electron beam.

The ²²⁶Ra metal is preferably electroplated or liquid-deposited as a salt onto the inner surface of the target capsule, followed by drying. Solid radium salt particles are preferably used as the target, and are preferably prepared in situ by drying a solution of a water-soluble radium salt such as a nitrate or halide.

The one or more target capsules 220 are generally referred to herein as a “capsule” for ease of expression and not because of having the shape of a medicinal capsule. Similarly, capsules used in space travel were not shaped like medicinal capsules but were shaped as truncated cones.

The word “lid” is also used here for convenience as such a covering is typically present at the top of a chamber when viewed in the longest vertical axis of the chamber and covers an opening at the top in that position. In the present invention, the capsule lid 232 can be at a first end of the capsule opposite a second end of the capsule, where each of the first end and the second end are generally positioned along a common axis of the capsule.

In a preferred embodiment, as shown in FIG. 6, the common axis along which the first and second capsule ends are positioned is a “short” axis of the capsule that is parallel to the direction of the electron beam. That “short axis” is a different axis from a “long” axis of the depicted capsule and is usually perpendicular to the axis of the electron beam. In other embodiments, the common axis along which the first and second ends are positioned is the “long” axis of the capsule. In other words, the capsule can be provided in the form of a shape having different lengths, heights, and thicknesses. Further, the lid can be positioned along any of these axes.

Here, the capsule “lid” is, in most instances, a portion of the capsule whose inner surface, relative to the capsule, is coated with the tantalum layer that is impacted by the electron beam.

The word “lid” here is usually used to close and hermetically seal the target-containing capsule, although other sealing devices at other locations can also be used to sealingly-close the capsule. The lid 232 and its sealingly-closing of the capsule helps prevent radon gas and radium (and any other radioactive material) from escaping outside the capsule after a long irradiation period and heating.

The one or more target capsules 220 are preferably made out of aluminum (e.g., an aluminum wall 236) due in part because of its weld-ability (e.g., the ability to join with a hermetic seal). Aluminum also has good mechanical properties (yield strength/ultimate strength) and, to a lesser extent, high thermal conductivity and high melting temperature. The latter two properties should not be of great import as because the conduction length scales (wall thickness) are small to keep the volumetric generation minimized.

Diamond et al., J Appl Phys 129:104901 (Mar. 9, 2021) report that one-half mm of aluminum on both sides of a radium target produces little reduction in the bremsstrahlung intensity, even when multiple segments are used, but provides excellent protection against target rupture during irradiation and handling. Aluminum is a good choice for target cladding because it has been used in high-powered electron beams with little degradation from such processes as oxidation by the radiolysis products of water.

Other materials with similar properties include silicon carbide (SiC), titanium, and Inconel® 718, as well as aluminum alloys, titanium alloys, and stainless steel alloys. There is also less volumetric heating with the low-Z materials.

Regardless of the shape or material of construction, the target capsule lid 232 is optionally coated on its inner surface with a high-Z material, illustratively such as tantalum (Ta) 234. The thickness of an illustrative Ta coating 234 is about 120 to about 220 microns (μ). Preferably, the thickness of high-Z material coating 234 is about 150 to about 190μ, and more preferably, it is about 160 to about 180μ. The high-Z material coating is preferably sprayed onto the metallic surface of the capsule lid, which becomes the inner surface of the capsule lid after closure.

Tantalum has been used as a converter for the production of Bremsstrahlung photons in electron beam bombardment of radium at thicknesses of about 1 to about 3 mm [Diamond et al., J Appl Phys 129:104901 (Mar. 9, 2021)]. Such tantalum thicknesses are up to about 20-fold greater than those utilized herein.

The one or more target capsules 220 can include an air gap 238. The air gap 238 surrounds and/or contacts the high-Z material coating 234 and the ²²⁶Ra target 230. The air gap 238 can act as a heat sink to dissipate heat during activation of the ²²⁶Ra target 230.

The target capsule enclosure system 200 further includes a beam stop 240 positioned behind the one or more target capsules 220. The beam stop 240 is preferably comprised of a gamma-radiation shielding material as are well-known. Illustrative beam stop materials include high density (HD) concrete blocks, supplied by Veritas Medical Solutions, Harleysville, PA, USA, and stainless steel. The beam stop 240 is positioned along the incident path (e.g., the same axis) as the electron beam 216.

Further, because the bombardment process can cause the target capsule enclosure system 200 to heat up, the target capsule enclosure system 200 preferably includes a volume 250 for a cooling medium or heat sink. In some embodiments, the cooling volume 250 is comprised of gas. In a preferred embodiment, the cooling volume 250 is filled with air. In other embodiments, the cooling volume 250 is filled with a liquid coolant such as water.

After electron bombardment of the target ²²⁶Ra-containing capsule has ceased, the hermetically sealed target capsule is opened, the produced ²²⁵Ac is separated from the remainder of the starting ²²⁶Ra and various reaction products and daughter radionuclides. These separation methods are well known in the art and include elution processing, including the use of diglycolamide (DGA) materials dispersed onto a porous inert resin or silica support as discussed in U.S. Pat. Nos. 7,087,206, 7,157,022 and 7,553,461. So-called UTEVA® (Uranium and TEtraValent Actinides) (dipentyl pentylphosphonate) resins, both of which are available from Eichrom Technologies, Inc.

Illustratively, radium is provided by EZAG/Georgia (Atlanta, GA, USA) with 10 μCi of ²²⁶Ra activity in a solution of 0.1 M HCL. The activation (i.e., formation of a radioisotope product) can be for 30 hours at LEAF at ANL, or IBA in Belgium. LEAF is a good source for this activation because of the redundancy of their beamlines and the existence of a universal target station and hot cell.

The produced ²²⁵Ac is thereafter usually recovered. The recovery is typically as an aqueous salt solution of a pharmaceutically acceptable anion such as nitrate or a halide such as chloride or bromide. DGA resins available from Eichrom Industries, Inc. (Lisle, IL, USA) are useful for separation of aqueous solutions of actinium salts from radium salts.

Illustratively of a commercial product containing ²²⁵Ac, an FDA-approved ²²⁵Ac nitrate aqueous solution is available from Oak Ridge National Laboratory. The ²²⁵Ac so produced is typically diluted in a pharmaceutically acceptable aqueous diluent for use.

FIG. 7 illustrates a combined control system 300 that can be provided to integrate individual control systems of the accelerator 110, and beamline 130 discussed in reference to FIG. 5 to produce an electron beam, such as the electron beam 216 discussed in reference to FIG. 6.

The combined control system 300 includes a beamline subsystem 305. The beamline subsystem can include a first beam optics 310 that accepts an electron beam from the accelerator 110.

The beam optics 310 can be used to correct and steer the electron beam received from the accelerator 110. The beam optics 310 can be coupled to a diagnostic component 320 that can be used to analyze a current or a position of the electron beam. The diagnostic component 320 can further be coupled with a second beam optics 330 used for focusing the electron beam.

The second beam optics 330 can be coupled with a third beam optics 340 for further correcting and steering the electron beam. Therefrom, the third beam optics 340 can be coupled with a fourth beam optics 350 comprising an achromatic bend system.

In an exemplary embodiment, the achromatic bend system facilitates the bending of the electron beam. For instance, three magnets are used for the achromatic bend system to bend the electron beam path 270°. The first and third magnets each provide a 70° bend and the second magnet provides a bend of 130° to provide the complete bend of 270°.

From the fourth beam optics 350, the electron beam can travel down one of three paths. If the electron beam matches one or more predetermined criteria for production, the electron beam can be bent by the fourth beam optics 350 toward a second diagnostic component 360 for further analysis of the current or the position of the electron beam.

The second diagnostic component 360 can be coupled with a fifth beam optics 370 for correction and steering, which can further be coupled with a sixth beam optics 380 for focusing. The sixth beam optics 380 can be coupled to a third diagnostic component 390 for another current and position analysis of the electron beam before transporting the electron beam to a target (such as ²²⁶Ra housed in the target holder 150 described above with reference to FIG. 5).

Alternatively, if the electron beam does not match the predetermined criteria for production, the fourth beam optics 350 can pass the electron beam to a fourth diagnostic component 392. In some embodiments, the fourth diagnostic component 392 includes a beam dump or beam stop. However, if the electron beam is not used for production, the fourth beam optics 350 can pass the electron beam to a fifth diagnostic component 394 such as a spectrometer for further analyzing.

In an exemplary embodiment, the electron beam can enter and exit the fourth beam optics 350 in substantially the same plane. That is to say, the achromatic bend system of the fourth beam optics 350 does not affect a vertical elevation of the electron beam.

However, in other embodiments, the electron beam can exit the fourth beam optics 350 in a different plane than the plane at which the electron beam enters the fourth beam optics 350. In other words, in some cases, the achromatic bend system of the fourth beam optics 350 can affect the vertical elevation of the electron beam.

It can be appreciated that the beamline subsystem 305 can include other variations, such as the addition or omission of certain components. Such variations are within the spirit of this disclosure.

The electron activation and delayed counting method is very suitable for investigating the total production cross-section of ²²⁵Ac. Several electron accelerator facilities (national and international) can provide electron beams at about 40 MeV energy. For example, the Low-Energy Accelerator Facility (LEAF) at Argonne National Laboratory (ANL) is very convenient. Additionally, IBA in Belgium can facilitate this mission. Other accelerator facilities can be contacted and utilized, such as ELBE in Dresden, Germany, or the IBA TT300-HE Rhodotron® facility at NorthStar Medical Radioisotope, LLC in Beloit, WI, USA.

Illustratively, the ²²⁵Ac yield measurement is obtained by bombarding a target of a homogenized mixture of 100 μg of RaBr₂ and 1 mg of Al₂O₃ (acting as a filler) placed inside a hollow cylinder with generally rounded ends (e.g., a capsular structure) 8 mm in diameter and 5 mm in height and to be covered with a 0.1 mm thick aluminum lid 232 and placed inside the activation vacuum chamber. The activation process (e.g., the bombardment of the target 230 in the target holder 150) is for about 30 hours. Then, an offline measurement can be carried out to determine the activities of the activation products using a gamma-ray detector.

The electron-beam current is monitored for the total charge using a methods and apparatus well-known to those skilled in the art. One illustrative apparatus is a Faraday cup. Another illustrative apparatus is a current transformer, also sometimes referred to as a current transducer, such as the ACCT device sold by Bergoz Instrumention headquartered in Saint-Genis-Pouilly, France.

The total production cross-section of ²²⁵Ac (from both neutron and proton removal channels) can be directly obtained by measuring the activity of the 218.0 keV (I_{γ}=11.44%) gamma line resulting from the decay of ²²¹Fr (T_{1/2}=4.801 m) and measuring the activity of the 440.45 keV (I_{γ}=25.9%) gamma line from the decay of ²¹³Bi(T_{1/2}=45.59 minutes, β⁻ BR: 97.86%), which both are in secular equilibrium with ²²⁵Ac during the counting period.

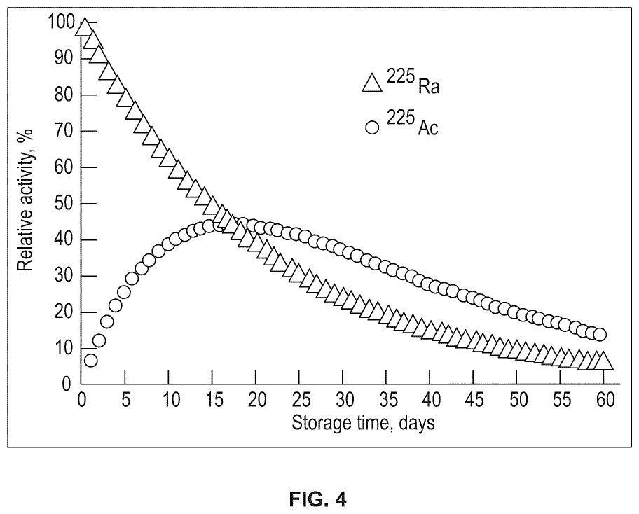

The period for counting is typically less than an hour on day 18 after the end of the bombardment process. Referring back to FIG. 4, it is shown that the expected maximum relative activity of ²²⁵Ac occurs on day 18 [Maslov et al., Radiochemistry, 48(2):195-197 (2006)]. The detection utilizes an HPGe detector with a standard lead shielding.

Although there are no reported measurements of the ²²⁶Ra (e⁻,n)²²⁵Ra and ²²⁶Ra (e⁻,p)²²⁵Fr −β decay→²²⁵Ra cross-sections, the measured data by Gerab et al., above, on a similar beam-target system, i.e., ²³⁸U(e⁻,n)²³⁷U, at the same proposed energy range of the electrons indicate that the yields of ²²⁵Ac are reasonable. The yield of ²²⁵Ra is calculated using a 100 mg of ²²⁶Ra, which is equivalent to about 2.7E+20 atoms of radium.

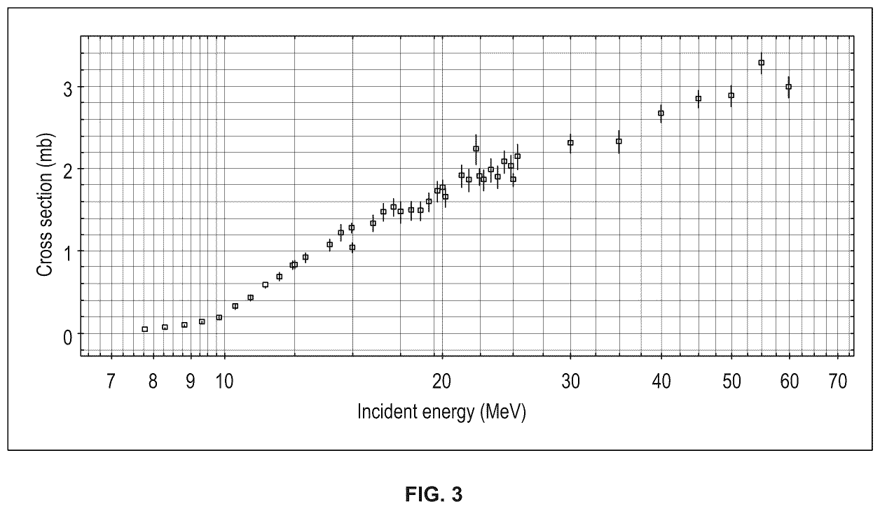

The total production cross-section at an electron beam energy of 39 MeV (mid-target energy) is equal to (2×2.5) milli-barn (mb; 1E-27 square centimeter (cm²) as indicated in FIG. 3, where the sum of ²²⁶Ra (e⁻, n)²²⁵Ra and ²²⁶Ra (e⁻, p)²²⁵Fr is about double the value of ²³⁸U(e⁻,n)²³⁷U cross-section. The beam current of 3.125 mA, with a full width at half-maximum (FWHM), also called half-power beam width, beam spot of 7 mm results in an electron flux of 4.9E+16 e⁻/(cm²·s). [e−/(cm²·s) is the unit of flux for the number of incident electrons per unit area per unit time.]

The reaction rate is then equal to 4E+10 of ²²⁵Ra/s, some of which will decay during the production with a decay constant of 5.38E-7 (1/s). [²²⁵Ra/s is the number of ²²⁵Ra atoms produced per unit time, used here to provide the production rate of the important ²²⁵Ra-isotope that decays to ²²⁵Ac; 1/s is the decay constant unit or the probability for a single disintegration to take place per unit time.]After 6.5 days of bombardment, the total number of ²²⁵Ra atoms produced is 2E+16 atoms, to be compared with the 3E+15 atoms of ²²⁵Ra estimated using the simulated photon flux shown in FIG. 1 for a tantalum converter (two discs).

The high-intensity electron beam bombardment (e.g., irradiation) is carried out for a time sufficient to produce a desired amount of ²²⁵Ac, taking into account the decay of ²²⁵Ac. Typical bombardment (e.g., irradiation) times are 4 to about 30 days, and preferably about 10 to about 25 days.

Each of the patents, patent applications and articles cited herein is incorporated by reference. The use of the article “a” or “an” is intended to include one or more.

The foregoing description and the examples are intended as illustrative and are not to be taken as limiting. Still, other variations within the spirit and scope of this invention are possible and will readily present themselves to those skilled in the art.

1. A method for converting ²²⁶Ra to ²²⁵Ac by electron beam bombardment with high energy electrons without the use of a converter that comprises the steps of:
a) bombarding a target comprised of ²²⁶Ra present within a hermetically sealed capsule with an electron beam having an average effective beam power of about 20 to about 250 kW at a beam energy of about 25 to about 100 MeV, said capsule having a capsule lid through which said beam of electrons passes prior to impacting said ²²⁶Ra, the capsule lid optionally having a high-Z material coating having a thickness of about 120 to about 220 microns (μ) on its internal capsular surface through which said beam of electrons also passes prior to impacting said ²²⁶Ra target; and
b) maintaining said bombardment for a time period sufficient to remove a neutron and or a proton from said ²²⁶Ra target and form ²²⁵Ac in a commercial scale.

2. The method according to claim 1, wherein the formed ²²⁵Ac is recovered.

3. The method according to claim 1, wherein said high-Z material coating is present.

4. The method according to claim 1, wherein said capsule is comprised of aluminum or titanium.

5. The method according to claim 4, wherein said capsule is provided in the form of a hollow cylinder with generally rounded ends, a hollow cone, or a hollow truncated cone.

6. The method according to claim 5, wherein said capsule lid is positioned at an end along an axis of the capsule that is different from a long axis of the capsule.

7. The method according to claim 5, wherein said capsule lid is positioned at the end of the capsule that is along a long axis of the capsule.

8. The method according to claim 1, wherein said time period for bombardment is maintained for about 4 days to about 30 days.

9. The method according to claim 1, wherein said average electron beam power is at about 60 to about 200 kW.

10. The method according to claim 1, wherein said beam energy is at about 25 to about 65 MeV electrons.

11. A method for converting a ²²⁶Ra target to ²²⁵Ac by electron beam bombardment of said ²²⁶Ra target with high energy electrons without the use of a converter that comprises the steps of:
a) bombarding a target comprised of ²²⁶Ra present within a hermetically sealed capsule with an electron beam having an average effective beam power of about 60 to about 200 kW at a beam energy of about 25 to about 65 MeV, said capsule having a capsule lid through which said beam of electrons passes prior to impacting said ²²⁶Ra, the capsule lid optionally having a high-Z material coating having a thickness of about 120 to about 220 microns (β) on its internal capsular surface through which said beam of electrons also passes prior to impacting said ²²⁶Ra target; and
b) maintaining said ²²⁶Ra target bombardment for a time period of about 4 days to about 30 days to form ²²⁵Ac in a commercial scale.

12. The method according to claim 11, wherein said ²²⁶Ra target is present as a halide or nitrate salt.

13. The method according to claim 11, wherein the formed ²²⁵Ac is recovered.

14. The method according to claim 11, wherein said capsule is comprised of aluminum.
